(19) United States
(12) Patent Application Publication
(10) Pub. No.: US 2024/0294208 A1
(43) Pub. Date: Sep. 5, 2024

(54) End of Travel Relief System for Power Steering System

(71) Applicant: R.H. Sheppard Co. Inc., Hanover, PA (US)

(72) Inventors: Jared Pitzer, York, PA (US); Thomas James, Dallastown, PA (US); Jeffrey Edward Titpon, Gettysburg, PA (US); Cory Alan Klinedinst, Hanover, PA (US)

(21) Appl. No.: 18/178,178

(22) Filed: Mar. 3, 2023

(51) Int. Cl. B62D 5/06; B62D 5/08; F04B 9/10

(52) U.S. Cl. CPC B62D 5/061; B62D 5/081; F04B 9/10

(57) ABSTRACT

A power steering system steering gear includes a piston indirectly coupled to a steering linkage and moved by a steering wheel and fluid pressure on opposite ends of the piston. A fluid bore extends between the opposite ends of the piston. An end of travel relief system includes poppet valves at opposite ends of the bore. Each valve includes a sleeve having an inboard end within the bore and an outboard end extending outward therefrom and defines a valve seat between the ends. A valve stem within the sleeve has an inboard end defining a poppet configured for engagement with the valve seat and an outboard end defining a stem. A reset body can be inserted into the bore between the valves. Depending on the direction of movement of the piston, the body engages the inboard end of a corresponding valve to establish a reset position of the valve.

### BACKGROUND OF THE INVENTION

### a. Field of the Invention

This disclosure relates to power steering systems. In particular, this disclosure relates to a steering gear for a power steering system and, more particularly, to an end of travel relief system in the steering gear that is less complex than conventional systems and that includes means for resetting the end of travel relief system that is easier to access and less complex than conventional systems.

### b. Background Art

Conventional vehicles include power steering systems that assist the vehicle operator in steering the vehicle by augmenting the force applied by the operator when turning the steering wheel. In commercial vehicles (sometimes referred to as heavy vehicles) such as trucks and buses, the power steering system typically includes a steering gear having a recirculating ball system in which an internally threaded piston with an external toothed rack engaged with a sector gear on a shaft connected to a Pitman arm is driven by (i) a recirculating ball screw rotating inside of the piston responsive to movement of the steering wheel and (ii) fluid forces acting on either side of the piston to augment the force provided by the vehicle operator through the steering wheel.

The power steering systems in commercial vehicles often include an end of travel relief system that limits the power-assisted movement of the piston to protect steering components from excess stress. A conventional end of travel relief system includes one or more poppet valves that are unseated when the piston reaches a predetermined extent of travel in either direction and divert some of the working fluid from the fluid chamber. The piston can continue to travel beyond this point, but the power-assistance forces provided by the fluid is reduced thereby reducing system temperature and mechanical stress on steering system components by preventing axle stops from contacting the vehicle axle under full fluid pressure.

Although conventional end of travel relief systems function well for their intended purpose, many systems are relatively complex, include a relatively large number of parts and are relatively expensive. Further, it may be desirable to reset an end of travel relief system in certain circumstances including during mechanical repairs to the vehicle steering system or a change of tires on the vehicle wheels. Conventional mechanisms for resetting end of travel relief systems, however, are often difficult to access, relatively complex, include a relatively large number of parts and are relatively expensive.

The inventors herein have recognized a need for a steering gear for a power steering system that will minimize and/or eliminate one or more of the above-identified deficiencies.

### BRIEF SUMMARY OF THE INVENTION

This disclosure relates to power steering systems. In particular, this disclosure relates to a steering gear for a power steering system and, more particularly, to an end of travel relief system in the steering gear that is less complex than conventional systems and that includes means for resetting the end of travel relief system that is easier to access and less complex than conventional systems.

One embodiment of a steering gear for a power steering system includes a housing defining a fluid chamber and a piston disposed within the fluid chamber and configured for movement within the fluid chamber along a first axis responsive to movement of an associated steering wheel and fluid pressure on first and second axial ends of the piston to cause corresponding movement of an associated steering linkage. The piston defines a fluid bore extending through the piston along a second axis from the first axial end of the piston to the second axial end of the piston. An end of travel relief system includes a first poppet valve having a sleeve configured to be received within a first axial end of the fluid bore. The sleeve of the first poppet valve has an inboard end disposed within the fluid bore and an outboard end extending outward from the fluid bore and defining a valve seat between the inboard and outboard ends of the sleeve of the first poppet valve. The first poppet valve further includes a valve stem disposed within the sleeve of the first poppet valve. The valve stem of the first poppet valve has an inboard end defining a poppet configured for engagement with the valve seat in the sleeve of the first poppet valve and an outboard end defining a stem configured to extend beyond the outboard end of the sleeve of the first poppet valve when the poppet of the valve stem of the first poppet valve engages the valve seat in the sleeve of the first poppet valve. The end of travel relief system further includes a second poppet valve having a sleeve configured to be received within the second axial end of the fluid bore. The sleeve of the second poppet valve has an inboard end disposed within the fluid bore and an outboard end extending outward from the fluid bore and defining a valve seat between the inboard and outboard ends of the sleeve of the second poppet valve. The second poppet valve further includes a valve stem disposed within the sleeve of the second poppet valve. The valve stem of the second poppet valve has an inboard end defining a poppet configured for engagement with the valve seat in the sleeve of the second poppet valve and an outboard end defining a stem configured to extend beyond the outboard end of the sleeve of the second poppet valve when the poppet of the valve stem of the second poppet valve engages the valve seat in the sleeve of the second poppet valve. The end of travel relief system further includes a reset body configured for movement along a third axis, perpendicular to the second axis, into the fluid bore between the first poppet valve and the second poppet valve. The reset body is configured for engagement with the inboard end of the sleeve of the first poppet valve during movement of the piston in a first direction to establish a reset position of the first poppet valve within the fluid bore of the piston and for engagement with the inboard end of the sleeve of the second poppet valve during movement of the piston in a second direction, opposite the first direction, to establish a reset position of the second poppet valve within the fluid bore of the piston.

Another embodiment of a steering gear for a power steering system includes a housing defining a fluid chamber and a piston disposed within the fluid chamber and configured for movement within the fluid chamber along a first axis responsive to movement of an associated steering wheel and fluid pressure on first and second axial ends of the piston to cause corresponding movement of an associated steering linkage. The piston defines a fluid bore extending through the piston along a second axis from the first axial end of the piston to the second axial end of the piston. An end of travel relief system includes a first poppet valve having a sleeve configured to be received within a first axial end of the fluid bore. The sleeve of the first poppet valve has an inboard end disposed within the fluid bore and an outboard end extending outward from the fluid bore and defining a valve seat between the inboard and outboard ends of the sleeve of the first poppet valve. The first poppet valve further includes a valve stem disposed within the sleeve of the first poppet valve. The valve stem of the first poppet valve has an inboard end defining a poppet configured for engagement with the valve seat in the sleeve of the first poppet valve and an outboard end defining a stem configured to extend beyond the outboard end of the sleeve of the first poppet valve when the poppet of the valve stem of the first poppet valve engages the valve seat in the sleeve of the first poppet valve. The end of travel relief system further includes a second poppet valve having a sleeve configured to be received within the second axial end of the fluid bore. The sleeve of the second poppet valve has an inboard end disposed within the fluid bore and an outboard end extending outward from the fluid bore and defining a valve seat between the inboard and outboard ends of the sleeve of the second poppet valve. The second poppet valve further includes a valve stem disposed within the sleeve of the second poppet valve. The valve stem of the second poppet valve has an inboard end defining a poppet configured for engagement with the valve seat in the sleeve of the second poppet valve and an outboard end defining a stem configured to extend beyond the outboard end of the sleeve of the second poppet valve when the poppet of the valve stem of the second poppet valve engages the valve seat in the sleeve of the second poppet valve. The end of travel relief system further includes reset position establishment means for establishing a reset position of the first poppet valve and a reset position of the second poppet valve.

One embodiment of a method for positioning an end of travel relief system in a steering gear of a power steering system includes inserting a reset body through a housing of the steering gear and into a piston disposed within a fluid chamber defined within the housing. The piston is configured for movement within the fluid chamber along a first axis responsive to movement of an associated steering wheel and fluid pressure on first and second axial ends of the piston to cause corresponding movement of an associated steering linkage. The reset body is inserted into a fluid bore in the piston extending through the piston along a second axis from the first axial end of the piston to the second axial end of the piston to position the reset body between first and second poppet valves of an end of travel relief system for the piston disposed in opposite ends of the fluid bore by moving the reset body in a first direction along a third axis, perpendicular to the second axis. The method further includes moving the piston in a first direction in the fluid chamber to cause engagement of the reset body with an inboard end of the first poppet valve and movement of the first poppet valve in a second direction, opposite the first direction, within the fluid bore to a reset position for the first poppet valve. The method further includes moving the piston in the second direction in the fluid chamber to cause engagement of the reset body with an inboard end of the second poppet valve and movement of the second poppet valve in the first direction within the fluid bore to a reset position for the second poppet valve.

A steering gear for a power steering system in accordance with the present teachings is advantageous relative to conventional systems. The end of travel relief system in the steering gear is less complex than conventional systems, has fewer parts and is relatively inexpensive. In particular, the end of travel relief system includes only two poppet valves whose position are controlled using only fluid pressure and mechanical pressure as the steering system reaches an axle stop. Further, the positions of the valves can be reset through a relatively simple process using a reset body that is easier to access, is less complex, has fewer parts and is less expensive than conventional reset systems.

The foregoing and other aspects, features, details, utilities, and advantages of the present teachings will be apparent from reading the following description and claims, and from reviewing the accompanying drawings.

### BRIEF DESCRIPTION OF THE DRAWINGS

FIG. 1 is a diagrammatic view of a power steering system.

FIG. 2 is a cross-sectional view of one embodiment of a steering gear for the power steering system of FIG. 1.

FIG. 3 is a transparent, perspective view of a portion of the steering gear of FIG. 2.

FIG. 4 is a cross-sectional view of a valve of an end of travel relief system of the steering gear of FIG. 2.

FIG. 5 is a perspective view of a valve stem of the valve of FIG. 4.

FIGS. 6A-6E are cross-sectional views of a portion of the steering gear of FIG. 2 including an end of travel relief system illustrating steps in a method for setting the position of the end of travel relief system.

FIG. 7 is a cross-sectional view of one embodiment of a reset body of an end of travel relief system of steering gear of FIG. 2.

### DETAILED DESCRIPTION OF THE INVENTION

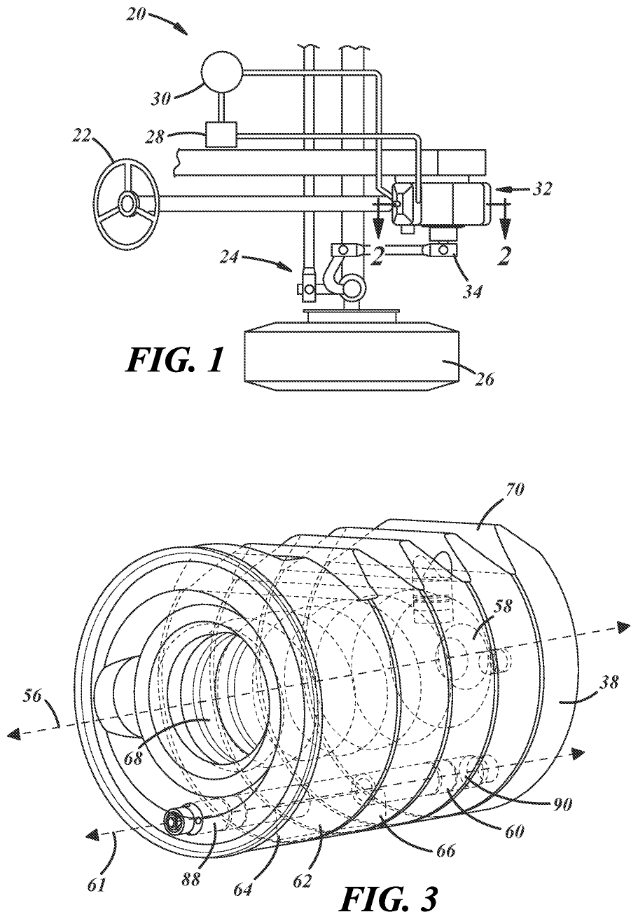

Referring now to the drawings wherein like reference numerals are used to identify identical components in the various views, FIG. 1 illustrates a power steering system 20 in accordance with the present teachings. System 20 is provided to transfer and augment forces input by the vehicle operator through a steering wheel 22 to a steering linkage 24 used in turning one or more steerable wheels 26 in a vehicle. System 20 may include a fluid reservoir 28, fluid pump 30, and a steering gear 32.

Fluid reservoir 28 stores a volume of power steering fluid used by steering gear 32 in augmenting the inputs of the vehicle operator. The size, shape and location of reservoir 28 may vary depending on the vehicle.

Fluid pump 30 extracts power steering fluid from fluid reservoir 28 and outputs the fluid at a relatively high pressure for delivery to steering gear 32. Pump 30 is conventional in the art.

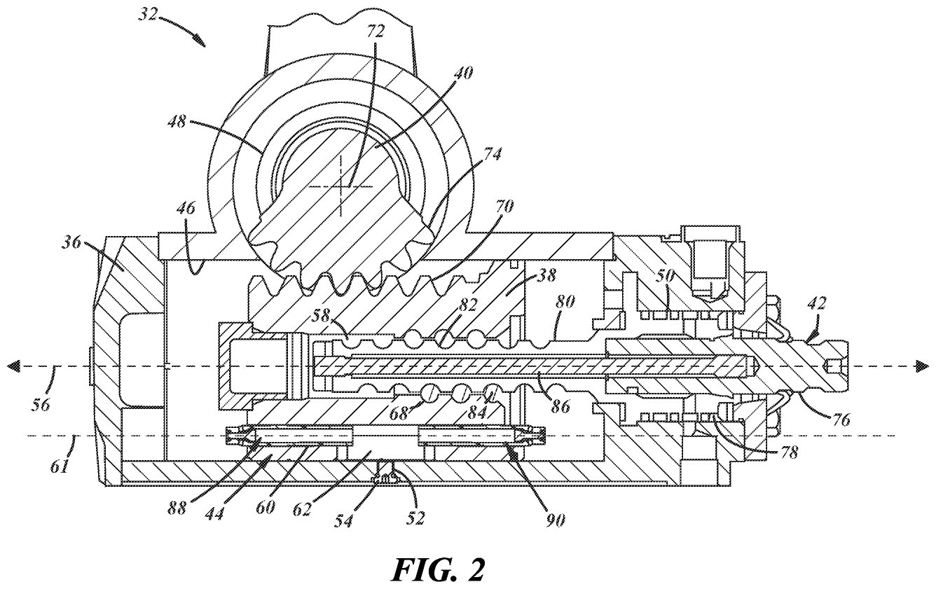

Steering gear 32 transfers forces input by the vehicle operator from steering wheel 22 to a Pitman arm 34 coupled to steering linkage 24 and augments those inputs to provide power-assisted steering. Referring now to FIG. 2, steering gear 32 may include a housing 36, a piston 38, a sector gear shaft or Pitman arm shaft 40 and a fluid control valve 42. In accordance with the teachings disclosed herein, steering gear 32 may further include an end of travel (EOT) relief system 44.

Housing 36 positions and orients the other components of steering gear 32 and provides protection to those components from foreign objects and elements. Housing 36 may be made from conventional metals and metal alloys. The exact configuration of housing 36 will be dependent on the configuration of the other components of steering gear 32 including elements of the EOT relief system 44 described hereinbelow. Housing 36 defines a fluid chamber 46 configured to receive piston 38, a bore 48 extending transverse to the fluid chamber 46 and configured to receive Pitman arm shaft 40, a bore 50 configured to receive valve 42 and a plurality of fluid passages for directing fluid to and from chamber 46 on opposite sides of piston 38. In accordance with one aspect of the teachings disclosed herein, housing 36 also discloses a bore 52 extending radially through housing 36 and into chamber 46. Bore 52 is configured to receive a component of EOT relief system 44 that is used in a method for setting a position of EOT relief system 44, and, more particularly, in establishing a reset position for EOT relief system 44 as described in greater detail below. A plug 54 may be used to seal bore 52 once the reset position is established.

Piston 38 forms part of a hydraulic motor formed within steering gear 32. Piston 38 is disposed within fluid chamber 46 and is configured for movement along an axis 56 within fluid chamber 46 responsive to movement of steering wheel 22 and fluid pressure on either side of piston 38. Piston 38 includes a bore 58 extending at least partway therethrough along axis 56 that is configured to receive a member of valve 42 and that is sealed at either end. Piston 38 further includes a fluid bore 60 extending through piston 38 along an axis 61 parallel to axis 56 from one end of piston 38 to the other end of piston 38. Bore 60 is configured to receive elements of EOT relief system 44 as discussed in greater detail below. Bore 60 may be substantially circular in shape. Referring to FIG. 3, piston 38 further defines an opening 62 extending from a radially outer surface of piston 38 into fluid bore 60. Referring to FIG. 2, opening 62 is configured for alignment with bore 52 in housing 36 and is configured to receive a component of EOT relief system 44 that extends through bore 52 and opening 62 and into fluid bore 60 and is used in a method for setting a position of EOT relief system 44, and, more particularly, in establishing a reset position for EOT relief system 44 as described in greater detail below. Referring again to FIG. 3, opening 62 may have a stadium or pill shape that is substantially rectangular, but with semicircular, longitudinal ends 64, 66. Opening 62 may be oriented such that longest dimension of opening 62 extends generally parallel to axis 56 or 61 and the semicircular ends 64, 66 of opening 62 are formed at the opposite axial ends of opening 62. Referring again to FIG. 2, piston 38 further defines a plurality of threads 68 on a radially inner surface extending along at least a portion of bore 60 for a purpose described below. Piston 38 also defines a toothed rack 70 on a radially outer surface configured for engagement with Pitman arm shaft 40.

Sector gear shaft or Pitman arm shaft 40 is configured to translate linear movement of piston 38 into rotational movement of Pitman arm 34. Shaft 40 is disposed within bore 48 of housing 36 and is configured for rotation about a rotational axis 72. Shaft 40 defines a sector gear 74 at one end configured to engage rack 70 on piston 38. The other end of shaft 40 is coupled to Pitman arm 34.

Fluid control valve 42 controls the flow of fluid from pump 30 to chamber 46 on either side of piston 38. Valve 42 is supported within housing 36 and in fluid communications with fluid inlets and outlets coupled to return and supply lines extending from fluid reservoir 28 and fluid pump 30 and with fluid passages extending between valve 42 and chamber 46 on opposite sides of piston 38. An inner member 76 of valve 42 may be coupled in a conventional manner to a steering column carrying steering wheel 22. An outer member 78 of valve 42 may define a recirculating ball screw 80 that extends into bore 58 of piston 38. Screw 80 defines a plurality of threads 82 configured to receive a plurality of balls 84 that circulate through the threads 68 in piston 38 and the threads 82 in screw 80. A torsion bar 86 may be coupled to members 76, 78 and biases members 76, 78 to predetermined relative positions. Rotation of inner member 76 responsive to inputs through steering wheel 22 twists torsion bar 86 and establishes a biasing force urging members 76, 78 to return to their predetermined relative positions.

In operation, rotation of steering wheel 22 by the vehicle operator causes rotation of inner member 76 of valve 42 relative to outer member 78 of valve 42. The change in relative position of members 76, 78 opens fluid passageways within valve 42 and allows high pressure fluid to flow from pump 30 to one side of the piston 44 (with the side depending on the direction of rotation of steering wheel 22). The change in relative position also twists torsion bar 86 establishing a biasing force in torsion bar 86. The fluid pressure in chamber 46 causes movement of piston 38 to augment the steering forces input by the vehicle operator (and causes fluid to drain from the other side of the piston 38). Movement of piston 38 along axis 56 causes corresponding rotation of Pitman arm shaft 40 about axis 72 and rotation of Pitman arm 34 which converts the rotational motion of shaft 40 into linear motion in linkage 24. Movement of piston 38 along axis 56 also causes rotation of screw 80 and outer member 78 of valve 42 relative to inner member 78 of valve 42 to return members 76, 78 to their predetermined relative positions (and close valve 42) once the wheels 26 have turned to the extent corresponding to the degree of rotation of the steering wheel 22.

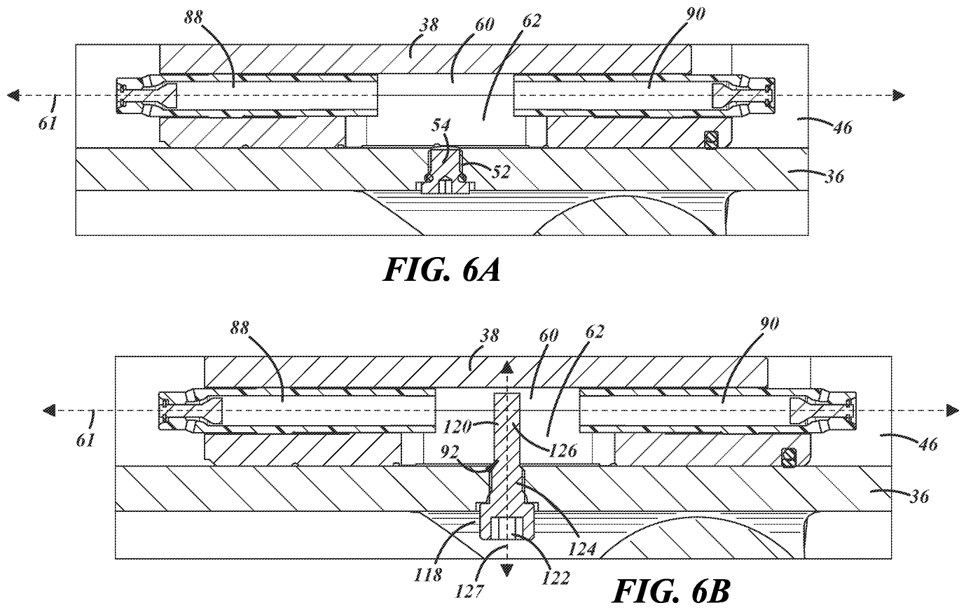

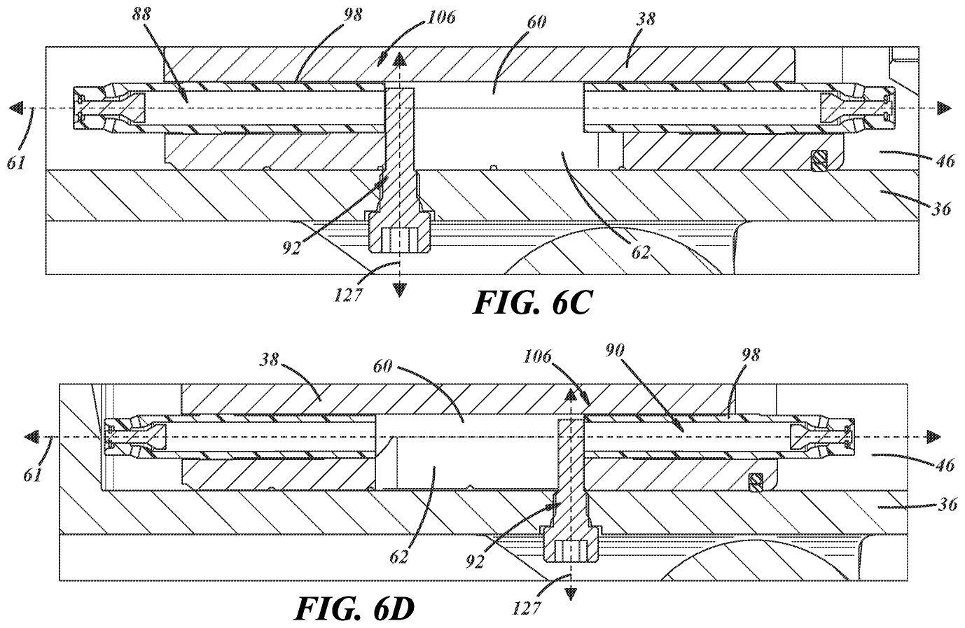

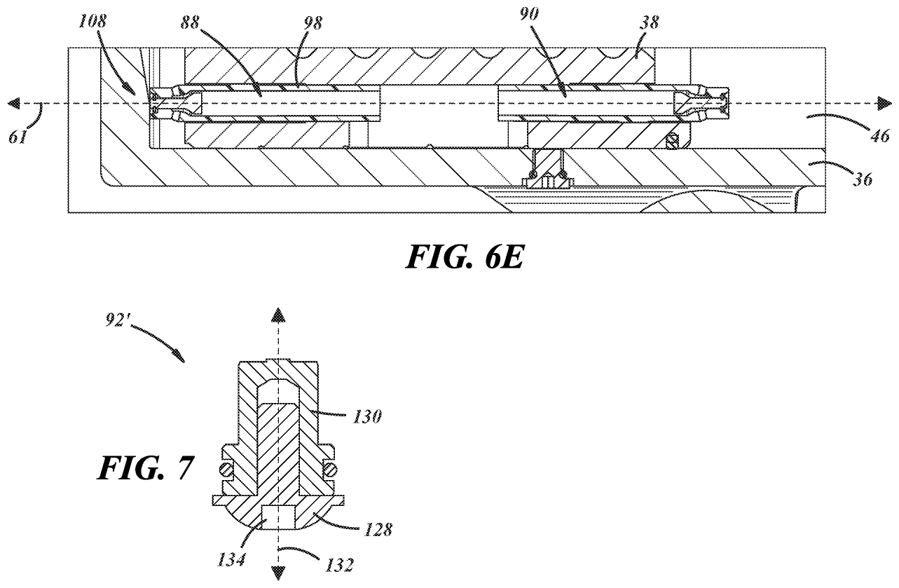

EOT relief system 44 is provided to limit the power-assisted movement of piston 38 to protect steering components from excess stress. In accordance with the teachings disclosed herein, EOT relief system 44 may include a pair of poppet valves 88, 90 and, referring to FIGS. 6B-6D, may further include reset position establishment means, such as a reset body 92, for establishing a reset position of valve 88 and a reset position of valve 90.

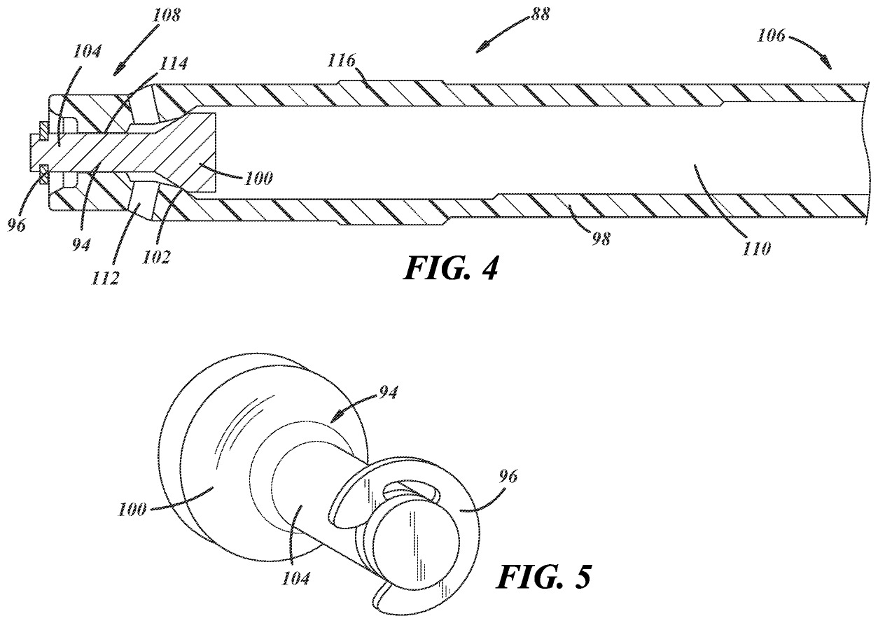

Valves 88, 90 provide end of travel relief for power steering assembly 20 by diverting some of the working fluid from a corresponding side of fluid chamber 46 when piston 38 reaches a predetermined limit of travel in either direction along axis 56. Valves 88, 90 may also act as pressure relief valves or bypass valves to move fluid from one side of piston 38 to the other side of piston 38 within chamber 46 when pump 30 is not operating to prevent over pressurization of power steering assembly 20. Valves 88, 90 may comprise poppet valves. Referring to FIG. 4, each valve 88, 90 may include a valve stem 94, a retainer clip 96 and a sleeve 98.

Valve Stem 94 controls the flow of fluid through valve 88 or 90. Valve stem 94 is disposed within sleeve 98. Referring to FIGS. 4-5, an inboard end of valve stem 94 defines a poppet 100 configured for engagement with a valve seat 102 formed in sleeve 98. In the illustrated embodiment, poppet 100 and valve seat 102 are hemispherical in shape. It should be understood, however, that the shape of poppet 100 and valve seat 102 may vary as long as the shapes of poppet 100 and valve seat 102 are complementary and may, for example, be tapered, disc-shaped or conical in other embodiments. An outboard end of valve stem 94 defines a stem 104 that may extend beyond outboard end of sleeve 98. Stem 104 may include a circular or semicircular groove configured to receive retainer clip 96.

Retainer clip 96 is configured to limit movement of valve stem 94 relative to sleeve 98 in an inboard direction. Clip 96 may be received within the groove formed in stem 104 of valve stem 94.

Sleeve 98 is configured to house valve stem 94 and defines a valve seat 102 for valve stem 94. In accordance with one aspect of the disclosed embodiments, sleeve 98 is also configured for engagement with reset body 92 to establish a reset position for the valve 88 or 90. Sleeve 98 is configured to be received within a corresponding end of fluid bore 60 of piston 38 such than an inboard end 106 of sleeve 98 and valve 88 or 90 is disposed with bore 60 and an outboard end 108 of sleeve 98 and valve 88 or 90 extends outward from bore 60. Sleeve 98 is generally cylindrical in shape. An inner diameter of sleeve 98 varies along the axial length of sleeve. The inner diameter may be greatest proximate the inboard end 106 of sleeve 98 where the interior of sleeve 98 forms a fluid passage 110 for movement of fluid. Moving in the direction from inboard end 106 towards outboard end 108, the inner diameter decreases proximate outboard end 108 to form valve seat 102 for poppet 100 of valve stem 94. A plurality of circumferentially spaced fluid ports 114 may be formed in sleeve 98 proximate outboard end 108 of sleeve 98 on an opposite side of valve seat 102 relative to poppet 100 and may extend in a substantially radial direction from passage 110 to a radially outer surface of sleeve 98. Continuing to move in the direction from inboard end 106 to outboard end 108, the inner diameter of sleeve 98 may decrease further to define a bore 114 sized and configured to receive stem 104 of valve stem 94 and to prevent fluid from passing through bore 114. Thereafter, the inner diameter of sleeve 98 may increase and may be sized and configured to receive retainer clip 96. The outer diameter of sleeve 98 may also vary. In particular, the outer diameter of sleeve 98 may define a portion 116 intermediate the inboard and outboard ends 106, 108 of sleeve 98 and valve 88 or 90 having a larger outer diameter than ends 106, 108 of sleeve 98 and valve 88 or 90. Portion 116 of sleeve 98 may be configured to be received within fluid bore 60 of piston 38 and to engage the surfaces of bore 60 of piston 38 in a press fit sufficient to prevent relative movement of sleeve 98 in the presence of fluid pressure within fluid chamber 46 and fluid bore 60, but still permit movement of sleeve 98 when the inboard end 106 or outboard end 108 of sleeve 98 comes into contact with a solid body.

Referring again to FIG. 2, during operation of power steering system 20, piston 38 is moved along axis 56 responsive to movement of steering wheel 22 and fluid pressure provided on one side of piston 38 with the direction of movement along axis 56 dependent upon the direction of rotation of steering wheel 22. If, for example, fluid pressure in fluid chamber 46 acts on the right side of piston 38 as shown in FIG. 2, the fluid pressure unseats poppet 100 of valve 90 and fluid flows through fluid ports 114 of sleeve 98 into fluid passage 110 of sleeve 98 and into bore 60 of piston 38. This fluid seats poppet 100 of valve 88 preventing fluid from bore 60 from passing into fluid chamber 46 on the left side of piston. As piston 38 continues to move to the left in FIG. 2, stem 104 of valve stem 94 of valve 88 will eventually contact the end wall of housing 36. Valve stem 94 is configured to contact the end wall of housing 36 at a point corresponding to an axle stop for the vehicle. For example, stem 94 may project from outboard end 108 of sleeve 98 by a predetermined distance corresponding to a predetermined position prior to axle stop. When stem 94 contacts the end wall of housing 36, poppet 100 of valve 88 is unseated allowing fluid to flow from fluid bore 60 and the right side of piston 38 through fluid ports 114 of sleeve 98 of valve 88 to the left side piston 38 to release fluid pressure.

Referring now to FIG. 6B, reset body 92 provides a means for establishing a reset position of poppet valves 88, 90 as discussed in greater detail below. Reset body 92 may have a structure similar to a conventional fastener including a head 118 and shank 120. Head 118 may include a socket 122 defined by one or more flats and configured to receive a tool used in rotating reset body 92. Shank 120 may include a threaded portion 124 and an unthreaded portion 126 and is sized to be received within bore 52 in housing 36. The threads on portion 124 may engage corresponding threads in bore 52 to secure reset body 92 in position. The unthreaded portion 126 extends along an axis 127 that is generally perpendicular to axis 61 (and axis 56) through opening 62 in piston 38 and into fluid bore 60 of piston 38 and is configured for engagement with the inboard ends 106 of sleeves 98 of valves 88, 90 as discussed below.

Although a particular form of reset body 92 is illustrated in FIG. 6B, it should be understood that the form of reset body 92 may vary. For example, in the embodiment illustrated in FIG. 6B, reset body 92 is configured to replace plug 54 following removal of plug 54 from bore 52 in housing 36. In alternative embodiments, the reset body may be configured in a manner that allows the reset body to remain within bore 52 at all times and enables valves 88, 90 to be moved to the reset position without opening the hydraulic circuit through bore 52. Referring to FIG. 7, for example, a reset body 92′ may include a fixed member 128 and a movable member 130. As used herein, “fixed” and “movable” as applied to members 128, 130 refers to the potential for members 128, 130 to move along a longitudinal axis 132 of reset body 92′ that extends and towards and away from fluid bore 60 in piston 38. In the illustrated embodiment, fixed member 128 comprises a screw that is configured for rotation about axis 132, but does not move along axis 132. Member 128 defines a plurality of threads on a radially outer surface. Member 128 may define a recess 134 in one axial end configured to receive a tool used for rotating member 128 about axis 132. Movable member 130 is configured for movement along axis 132 relative to fixed member 128. Movable member 130 comprises a nut having a tubular body with a closed end and an open end configured to receive fixed member 128. Member 130 defines a plurality of threads on a radially inner surface configured for engagement with the plurality of threads on the radially outer surface of member 128. The threads on members 128, 130 provide a means for inhibiting movement of movable member 130 along longitudinal axis 132 in the absence of a positioning force causing rotation of fixed member 128. The outer diameter of member 130 may have an eccentric shape that is complementary to the shape of bore 52 in housing 36 of steering gear 32 in which reset body 92′ is disposed in order to prevent rotation of movable member 130 about axis 132. Rotation of member 128 causes member 130 to be move between an extended position in which movable member 130 is disposed within fluid bore 60 for contact with the inboard ends 106 of sleeves 98 of valves 88, 90 and a retracted position in which the movable member 130 is withdrawn from fluid bore 60 and does not contact the inboard ends 106 of sleeves 98 of valves 88, 90. Additional potential structures for the reset body may be found in embodiments for reset body 92 may be found in commonly assigned U.S. Pub. No. 2022/0073132 A1, the entire disclosure of which is incorporated herein by reference.

Referring now to FIGS. 6A-B a method for setting the position of the EOT relief system 44 for power steering system 20 may begin with the steps of removing plug 54 from bore 52 in housing 36 and inserting reset body 92 through bore 52 in housing 36 and into opening 62 in piston 38 disposed within fluid chamber 46 of housing 36. Reset body 92 may be inserted through bore 52 in housing 36 along axis 127 until the threads on portion 124 of reset body 92 engage the threads in bore 52 of housing 36. Reset body 92 may then be rotated until head 118 of reset body 92 reaches the bottom of the counterbore formed in bore 52. Upon insertion, portion 126 of reset body 92 extends through opening 62 in piston 38 and into fluid bore 60 of piston 38 between valves 88, 90 and, in particular, between the inboard ends 106 of sleeves 98 of valves 88, 90 and valves 88, 90.

Referring to FIG. 6C, the method may continue with the step of moving piston 38 in a first direction in fluid chamber 46 (to the right in FIG. 6C) to cause engagement of reset body 92 with inboard end 106 of sleeve 98 and valve 88 and movement of valve 88 in a second direction (to the left in FIG. 6C), opposite the first direction, within fluid bore 60 to a reset position for valve 88. Piston 38 may be moved by lifting the vehicle off of the ground using a conventional jack or lift and then turning steering wheel 22 in one rotational direction to cause corresponding movement of piston 38. As piston 38 moves (to the right in FIG. 6C), piston 38 and, opening 62 in piston 38, will move relative to reset body 92 and reset body 92 will be brought into engagement with inboard end 106 of sleeve 98 of valve 88. Continued movement of piston 38, and opening 62 in piston 38, relative to reset body 92 will cause movement of valve 88 within fluid bore 60 (to the left in FIG. 6C). Eventually, reset body 92 will engage the semicircular end 64 of opening 62 (see FIG. 3) in piston 38 and further movement of piston 38 will not be possible. At this point, valve 88 will be in the reset position for valve 88.

Referring to FIG. 6D, the method may continue with the step of moving piston 38 in the second direction in fluid chamber 46 (to the left in FIG. 6D) to cause engagement of reset body 92 with inboard end 106 of sleeve 98 and valve 90 and movement of valve 90 in the first direction (to the right in FIG. 6D), opposite the second direction, within fluid bore 60 to a reset position for valve 90. With the vehicle already off the ground, piston 38 may be moved turning steering wheel 22 in the opposite rotational direction to cause corresponding movement of piston 38. As piston 38 moves (to the left in FIG. 6D), piston 38 and, opening 62 in piston 38, will move relative to reset body 92 and reset body 92 will be brought into engagement with inboard end 106 of sleeve 98 of valve 90. Continued movement of piston 38, and opening 62 in piston 38, relative to reset body 92 will cause movement of valve 90 within fluid bore 60(to the right in FIG. 6D). Eventually, reset body 92 will be engage the other semicircular end 66 of opening 62 (see FIG. 3) in piston 38 and further movement of piston 38 will not be possible. At this point, valve 90 will be in the reset position for valve 90.

In addition to establishing reset positions for valves 88, 90 of the EOT relief system 44, the method may include additional steps to establish EOT relief positions for valves 88, 90 for use during operation of the vehicle. Referring again to FIGS. 6A-B, the method may continue with the step of removing reset body 92 from fluid bore 60 of piston 38, opening 62 in piston 38 and bore 52 in housing 36 and reinserting plug 54 into bore 52. Referring now to FIG. 6E, the method may continue with the step of moving piston 38 in the second direction in fluid chamber 46 (to the left in FIG. 6E) to a first axle stop position corresponding to an axle stop position on the vehicle. Piston 38 may again be moved by rotating steering wheel 22 while wheels 26 are lifted off the ground. As piston 38 moves to the first axle stop position, the outboard end 108 of sleeve 98 of valve 88 engages the end wall of housing 36 causing valve 88 to begin moving in an inboard direction into fluid bore 60 of piston 38. Piston 38 continues to move towards the end wall of housing 36—and valve 88 continues to move further inward into fluid bore 60—until the first axle stop position is reached. At this point, valve 88 has assumed an end of travel relief position for valve 88. During subsequent operation of the vehicle, fluid pressure acting on the right-hand side of piston 38 will cause valve 88 to close and stem 104 of valve stem 94 in valve 88 to project beyond outboard end 108 of sleeve 98 of valve 88. Therefore, subsequent attempts to reach the axle stop position during operation of the vehicle will unseat poppet 100 of valve stem 94 from valve seat 102 in sleeve 98 of valve 88 and open valve 88 to allow fluid flow through valve 88 and reduce fluid pressure on the right-hand side of piston 38 and prevent power steering system from reaching the axle stop position as discussed hereinabove.

Once the end of travel relief position for valve 88 is set, the method may continue with moving piston 38 in the first direction in fluid chamber 46 (to the right in FIG. 6E) to a second axle stop position corresponding to an axle stop position of the vehicle. Piston 38 may again be moved by rotating steering wheel 22 while wheels 26 are lifted off the ground. As piston 38 moves to the second axle stop position, the outboard end 108 of sleeve 98 of valve 90 engages the opposite end wall of housing 36 causing valve 90 to begin moving in an inboard direction into fluid bore 60 of piston 38. Piston 38 continues to move towards the end wall of housing 36—and valve 90 continues to move further inward into fluid bore 60—until the second axle stop position is reached. At this point, valve 90 has assumed an end of travel relief position for valve 90. During subsequent operation of the vehicle, fluid pressure acting on the left-hand side of piston 38 will cause valve 90 to close and stem 104 of valve stem 94 in valve 90 to project beyond outboard end 108 of sleeve 98 of valve 90. Therefore, subsequent attempts to reach the second axle stop position during operation of the vehicle will unseat poppet 100 of valve stem 94 from valve seat 102 in sleeve 98 of valve 90 and open valve 90 to allow fluid flow through valve 90 and reduce fluid pressure on the left-hand side of piston 38 and prevent power steering system from reaching the axle stop position as discussed hereinabove.

A steering gear 32 for a power steering system 20 in accordance with the present teachings is advantageous relative to conventional systems. The end of travel relief system 44 in the steering gear 32 is less complex than conventional systems, has fewer parts and is relatively inexpensive. In particular, the end of travel relief system 44 includes only two poppet valves 88, 90 whose position are controlled using only fluid pressure and mechanical pressure as the steering system reaches an axle stop. Further, the positions of the valves 88, 90 can be reset through a relatively simple process using a reset body 92 that is easier to access, is less complex, has fewer parts and is less expensive than conventional reset systems.

While the invention has been shown and described with reference to one or more particular embodiments thereof, it will be understood by those of skill in the art that various changes and modifications can be made without departing from the spirit and scope of the invention. For example, the over molding and clamping technology disclosed herein is not limited to wheel speed sensors, but may also be used for other sensors having similar mounting arrangements including transmission sensors and crankshaft sensors.

What is claimed is:

1. A steering gear for a power steering system, comprising:
a housing defining a fluid chamber;
a piston disposed within the fluid chamber and configured for movement within the fluid chamber along a first axis responsive to movement of an associated steering wheel and fluid pressure on first and second axial ends of the piston to cause corresponding movement of an associated steering linkage, the piston defining a fluid bore extending through the piston along a second axis from the first axial end of the piston to the second axial end of the piston; and,
an end of travel relief system comprising:
a first poppet valve having
a sleeve configured to be received within a first axial end of the fluid bore, the sleeve of the first poppet valve having an inboard end disposed within the fluid bore and an outboard end extending outward from the fluid bore and defining a valve seat between the inboard and outboard ends of the sleeve of the first poppet valve;
a valve stem disposed within the sleeve of the first poppet valve, the valve stem of the first poppet valve having an inboard end defining a poppet configured for engagement with the valve seat in the sleeve of the first poppet valve and an outboard end defining a stem configured to extend beyond the outboard end of the sleeve of the first poppet valve when the poppet of the valve stem of the first poppet valve engages the valve seat in the sleeve of the first poppet valve;
a second poppet valve having
a sleeve configured to be received within the second axial end of the fluid bore, the sleeve of the second poppet valve having an inboard end disposed within the fluid bore and an outboard end extending outward from the fluid bore and defining a valve seat between the inboard and outboard ends of the sleeve of the second poppet valve;
a valve stem disposed within the sleeve of the second poppet valve, the valve stem of the second poppet valve having an inboard end defining a poppet configured for engagement with the valve seat in the sleeve of the second poppet valve and an outboard end defining a stem configured to extend beyond the outboard end of the sleeve of the second poppet valve when the poppet of the valve stem of the second poppet valve engages the valve seat in the sleeve of the second poppet valve; and,
a reset body configured for movement along a third axis, perpendicular to the second axis, into the fluid bore between the first poppet valve and the second poppet valve, the reset body configured for engagement with the inboard end of the sleeve of the first poppet valve during movement of the piston in a first direction to establish a reset position of the first poppet valve within the fluid bore of the piston and for engagement with the inboard end of the sleeve of the second poppet valve during movement of the piston in a second direction, opposite the first direction, to establish a reset position of the second poppet valve within the fluid bore of the piston.

2. The steering gear of claim 1 wherein the sleeve of the first poppet valve includes a fluid port extending from a radially outer surface of the sleeve of the first poppet valve to an interior fluid passage of the sleeve of the first poppet valve.

3. The steering gear of claim 1 wherein a portion of the sleeve of the first poppet valve between the inboard and outboard ends of the sleeve of the first poppet valve has a larger outer diameter than the inboard and outboard ends of the sleeve of the first poppet valve, the portion of the sleeve of the first poppet valve configured to be received within the fluid bore of the piston and engage the piston in a press fit.

4. The steering gear of claim 1 wherein the valve stem of the first poppet valve includes a groove configured to receive a retainer clip configured to limit movement of the valve stem of the first poppet valve relative to the sleeve of the first poppet valve in an inboard direction.

5. The steering gear of claim 1 wherein the piston defines an opening extending from a radially outer surface of the piston into the fluid bore, the opening configured to receive the reset body.

6. The steering gear of claim 5 wherein an axial dimension of the opening is greater than an axial dimension of the reset body thereby allowing the piston to move axially relative to the reset body when the reset body is in the opening.

7. The steering gear of claim 1 wherein the housing includes a bore through which the reset body may be inserted into the fluid bore in the piston.

8. The steering gear of claim 7 wherein the reset body includes a plurality of threads configured to engage a corresponding plurality of threads in the housing.

9. A steering gear for a power steering system, comprising:
a housing defining a fluid chamber;
a piston disposed within the fluid chamber and configured for movement within the fluid chamber along a first axis responsive to movement of an associated steering wheel and fluid pressure on first and second axial ends of the piston to cause corresponding movement of an associated steering linkage, the piston defining a fluid bore extending through the piston along a second axis from the first axial end of the piston to the second axial end of the piston; and,
an end of travel relief system comprising:
a first poppet valve having
a sleeve configured to be received within a first axial end of the fluid bore, the sleeve of the first poppet valve having an inboard end disposed within the fluid bore and an outboard end extending outward from the fluid bore and defining a valve seat between the inboard and outboard ends of the sleeve of the first poppet valve;
a valve stem disposed within the sleeve of the first poppet valve, the valve stem of the first poppet valve having an inboard end defining a poppet configured for engagement with the valve seat in the sleeve of the first poppet valve and an outboard end defining a stem configured to extend beyond the outboard end of the sleeve of the first poppet valve when the poppet of the valve stem of the first poppet valve engages the valve seat in the sleeve of the first poppet valve;
a second poppet valve having
a sleeve configured to be received within the second axial end of the fluid bore, the sleeve of the second poppet valve having an inboard end disposed within the fluid bore and an outboard end extending outward from the fluid bore and defining a valve seat between the inboard and outboard ends of the sleeve of the second poppet valve;
a valve stem disposed within the sleeve of the second poppet valve, the valve stem of the second poppet valve having an inboard end defining a poppet configured for engagement with the valve seat in the sleeve of the second poppet valve and an outboard end defining a stem configured to extend beyond the outboard end of the sleeve of the second poppet valve when the poppet of the valve stem of the second poppet valve engages the valve seat in the sleeve of the second poppet valve; and,
reset position establishment means for establishing a reset position of the first poppet valve and a reset position of the second poppet valve.

10. The steering gear of claim 9 wherein the sleeve of the first poppet valve includes a fluid port extending from a radially outer surface of the sleeve of the first poppet valve to an interior fluid passage of the sleeve of the first poppet valve.

11. The steering gear of claim 9 wherein a portion of the sleeve of the first poppet valve between the inboard and outboard ends of the sleeve of the first poppet valve has a larger outer diameter than the inboard and outboard ends of the sleeve of the first poppet valve, the portion of the sleeve of the first poppet valve configured to be received within the fluid bore of the piston and engage the piston in a press fit.

12. The steering gear of claim 9 wherein the valve stem of the first poppet valve includes a groove configured to receive a retainer clip configured to limit movement of the valve stem of the first poppet valve relative to the sleeve of the first poppet valve in an inboard direction.

13. The steering gear of claim 9 wherein the piston defines an opening extending from a radially outer surface of the piston into the fluid bore, the opening configured to receive the reset position establishment means.

14. The steering gear of claim 13 wherein an axial dimension of the opening is greater than an axial dimension of the reset position establishment means thereby allowing the piston to move axially relative to the reset position establishment means when the reset position establishment means is in the opening.

15. The steering gear of claim 9 wherein the housing includes a bore through which the reset position establishment means may be inserted into the fluid bore in the piston.

16. The steering gear of claim 15 wherein the reset position establishment means includes a plurality of threads configured to engage a corresponding plurality of threads in the housing.

17. A method for positioning an end of travel relief system in a steering gear of a power steering system in a vehicle, comprising:
inserting a reset body through a housing of the steering gear and into a piston disposed within a fluid chamber defined within the housing, the piston configured for movement within the fluid chamber along a first axis responsive to movement of an associated steering wheel and fluid pressure on first and second axial ends of the piston to cause corresponding movement of an associated steering linkage, the reset body inserted into a fluid bore in the piston extending through the piston along a second axis from the first axial end of the piston to the second axial end of the piston to position the reset body between first and second poppet valves of an end of travel relief system for the piston disposed in opposite ends of the fluid bore by moving the reset body in a first direction along a third axis, perpendicular to the second axis;
moving the piston in a first direction in the fluid chamber to cause engagement of the reset body with an inboard end of the first poppet valve and movement of the first poppet valve in a second direction, opposite the first direction, within the fluid bore to a reset position for the first poppet valve; and,
moving the piston in the second direction in the fluid chamber to cause engagement of the reset body with an inboard end of the second poppet valve and movement of the second poppet valve in the first direction within the fluid bore to a reset position for the second poppet valve.

18. The method of claim 17, further comprising:
removing the reset body from the fluid bore of the piston;
moving the piston in the second direction in the fluid chamber to a first axle stop position thereby causing an outboard end of the first poppet valve to engage a first end wall of the housing and inboard movement of the first poppet valve within the fluid bore of the piston to a first end of travel relief position; and,
moving the piston in the first direction in the fluid chamber to a second axle stop position thereby causing an outboard end of the second poppet valve to engage a second end wall of the housing and inboard movement of the second poppet valve within the fluid bore of the piston to a second end of travel relief position.

19. The method of claim 17 wherein each of the first and second poppet valves includes
a sleeve configured to be received within the fluid bore, the sleeve having an inboard end disposed within the fluid bore and an outboard end extending outward from the fluid bore and defining a valve seat between the inboard and outboard ends of the sleeve
a valve stem disposed within the sleeve, the valve stem having an inboard end defining a poppet configured for engagement with the valve seat in the sleeve and an outboard end defining a stem and configured to extend beyond the outboard end of the sleeve when the poppet engages the valve seat in the sleeve.

20. The method of claim 17 wherein the reset body is inserted through a bore in the housing extending from a radially outer surface of the housing into the fluid chamber and through an opening in the piston extending from a radially outer surface of the piston into the fluid bore in the piston, the opening in the piston aligned with the bore in the housing and having an axial dimension greater than an axial dimension of the reset body thereby allowing the piston to move axially relative to the reset body when the reset body is in the opening.
